(19) United States
(12) Patent Application Publication
(10) Pub. No.: US 2025/0179845 A1
(43) Pub. Date: Jun. 5, 2025

(54) VEHICLE SECURITY LOCK

(71) Applicant: Carbolt B.V., Varssevenld (NL)

(72) Inventor: Gertjan Meijer, Sinderen (NL)

(21) Appl. No.: 18/964,970

(22) Filed: Dec. 2, 2024

Related U.S. Application Data
(60) Provisional application No. 63/604,370, filed on Nov. 30, 2023.

(51) Int. Cl. E05B 83/02; E05B 77/00; E05B 85/02

(52) U.S. Cl. CPC E05B 83/02; E05B 77/00; E05B 85/02

(57) ABSTRACT

A vehicle security lock includes a lock assembly adapted to mount to an interior surface of a vehicle including a lock assembly housing and a lock cylinder that moves relative to the lock assembly housing. The vehicle security lock includes one or more bolt assemblies adapted to mount to the interior surface of the vehicle. Each bolt assembly includes a bolt assembly housing, a bolt which moves relative to the bolt assembly housing, a bolt assembly housing cover affixable to the bolt assembly housing, and a bolt receiver mounted to a separate interior surface of the vehicle. The vehicle security lock includes one or more force transfer assemblies which mechanically transfer force between the lock assembly and the one or more bolt assemblies. Insertion of the lock cylinder into the lock assembly provides force through the one or more force transfer assemblies to the one or more bolt assemblies.

### CROSS REFERENCE TO RELATED APPLICATIONS

The present application claims the benefit of the filing date of U.S. Application No. 63/604,370, filed Nov. 30, 2023, the contents of which are expressly incorporated by reference in their entirety.

### TECHNICAL FIELD

The present specification generally relates to a security lock for a vehicle and, more specifically, a security lock for a vehicle with a bolt remote from and mechanically actuated by a lock. The present invention is an improvement over the locking system for vehicle doors or windows as shown and described in NLPN 1042326 and EPPN 3231970, both previously secured by this applicant.

### BACKGROUND

Aftermarket vehicle security door locks are known in the art. Accordingly, there exists a need in the art to provide an improved vehicle security lock.

### SUMMARY

The present teachings relate to a vehicle security lock. The vehicle security lock includes a lock assembly adapted to mount to an interior surface of a vehicle. The lock assembly includes a lock assembly housing and a lock cylinder that moves relative to the lock assembly housing. The vehicle security lock also includes one or more bolt assemblies adapted to mount to the interior surface of the vehicle. Each bolt assembly includes a bolt assembly housing, a bolt which moves relative to the bolt assembly housing, a bolt assembly housing cover which is affixable to the bolt assembly housing, and a bolt receiver mounted to a separate interior surface of the vehicle. The vehicle security lock includes one or more force transfer assemblies which mechanically transfer force between the lock assembly and each of the one or more bolt assemblies. Insertion of the lock cylinder into the lock assembly provides force through the one or more force transfer assemblies to each of the one or more bolt assemblies and moves the bolt of each of the one or more bolt assemblies into a locked position. Withdrawal of the lock cylinder from the lock assembly relieves the force through the one or more force transfer assemblies to each of the one or more bolt assemblies and allows the bolt of each of the one or more bolt assemblies to move into an unlocked position.

The present teachings relate to a process for locking doors of a vehicle. The process includes inserting a lock cylinder into a lock assembly housing, transferring force from a lock assembly to one or more bolt assemblies through a force transfer assembly, and a force moving a bolt into a locked position.

The present teachings relate to a security lock. The security lock includes a lock assembly adapted to mount to an interior surface. The lock assembly includes a lock assembly housing and a lock cylinder that moves relative to the lock assembly housing. The security lock also includes one or more bolt assemblies adapted to mount to the interior surface. Each bolt assembly includes a bolt assembly housing, a bolt which moves relative to the bolt assembly housing, a bolt assembly housing cover which is affixable to the bolt assembly housing, and a bolt receiver mounted to a separate interior surface. The security lock includes one or more force transfer assemblies which mechanically transfer force between the lock assembly and each of the one or more bolt assemblies. Insertion of the lock cylinder into the lock assembly provides force through the one or more force transfer assemblies to each of the one or more bolt assemblies and moves the bolt of each of the one or more bolt assemblies into a locked position. Withdrawal of the lock cylinder from the lock assembly relieves the force through the one or more force transfer assemblies to each of the one or more bolt assemblies and allows the bolt of each of the one or more bolt assemblies to move into an unlocked position.

### BRIEF DESCRIPTION OF THE DRAWINGS

The embodiments set forth in the Figures are illustrative and exemplary in nature and not intended to limit the subject matter. The following detailed description of the illustrative embodiments can be understood when read in conjunction with the appended Figures, where like structure is indicated with like reference numerals and in which:

FIG. 1 is a front view of a bolt assembly interior including an emergency release and a bolt in an unlocked position, according to an exemplary embodiment;

FIG. 2 is a front view of a bolt assembly interior including an emergency release and a bolt in a locked position, according to the embodiment of FIG. 1;

FIG. 3 is a front view of a bolt assembly interior where an emergency release has been removed and a bolt is in an unlocked position, according to the embodiment of FIG. 1;

FIG. 4 is a side view of a bolt assembly interior with an auxiliary spring in a normal operating position, according to the embodiment of FIG. 1.

FIG. 5 is a front view of a bolt assembly exterior, according to the embodiment of FIG. 1.

FIG. 6 is a perspective view of a bolt assembly, according to another exemplary embodiment.

FIG. 7 is a perspective view of a bolt assembly interior with a bolt assembly housing cover removed, according to the embodiment of FIG. 6.

FIG. 8 is a perspective view of a bolt assembly exterior, according to the embodiment of FIG. 6.

FIG. 9 is a perspective view of a security lock assembly in an unlocked position, according to an exemplary embodiment;

FIG. 10 is a perspective view of a security lock assembly in a locked position, according to the embodiment of FIG. 9.

FIG. 11 is a rear view of a security lock assembly in an unlocked position, according to the embodiment of FIG. 9;

FIG. 12 is a rear view of a security lock assembly in a locked position, according to the embodiment of FIG. 9;

FIG. 13 is a front view of a security lock assembly mounted to a vehicle in an unlocked position, according to an exemplary embodiment;

FIG. 14 is a front view of a bolt assembly mounted to a vehicle in a locked position, according to an exemplary embodiment;

FIG. 15 is a front view of a bolt assembly mounted to a vehicle in an unlocked position, according to the embodiment of FIG. 14;

FIG. 16 is a perspective view of a force transfer assembly with a bolt in a locked position, according to an exemplary embodiment; and

FIG. 17 is a perspective view of a force transfer assembly with a bolt in an unlocked position, according to the embodiment of FIG. 16.

### DETAILED DESCRIPTION

The security lock 10 of the present disclosure provides additional security to a vehicle. The security lock 10 is an additional theft prevention device to any stock vehicle door or hatch locks. The security lock 10 resides within a vehicle. The security lock 10 is capable of securing doors or hatches of almost any vehicle. The security lock 10 is particularly adapted to vehicles with a partition which separates the front of the vehicle from a storage section in the rear of the vehicle and trailers such as cargo trailers. The vehicle operator can access a lock assembly 100 from the front of the vehicle. The lock assembly 100 can be mounted to the partition such that the rear of the lock assembly 100 is in the storage area of the vehicle. The vehicle operator can use the lock assembly 100 in the front of the vehicle to move one or more bolt assemblies 200 into a locked position 50 or unlocked position 40.

The vehicle has an interior surface 20. Any interior surface 20 of the vehicle to which the lock assembly 100 or the one or more bolt assembly housings 202 is mountable is the interior surface 20. The lock assembly 100 is particularly useful when it is mounted to a partition in the vehicle. The one or more bolt assembly housings 202 may also be mounted to the interior surface 20. Alternatively, the one or more bolt receivers 210 may be mounted to the interior surface 20.

The vehicle has one or more separate interior surfaces 30. A separate interior surface 30 is any interior surface of a vehicle on a door, hatch, or other portion of the vehicle which moves relative to a body of the vehicle. A separate interior surface 30 can have a bolt receiver 210 mounted to it. Alternatively, a separate interior surface 30 may have a bolt assembly housing 202 mounted to it. For any separate interior surface 30 which is to be secured by the security lock 10, a bolt assembly housing 202 is attached to the interior surface 20 and a bolt receiver 210 is attached to the separate interior surface 30 or vice versa.

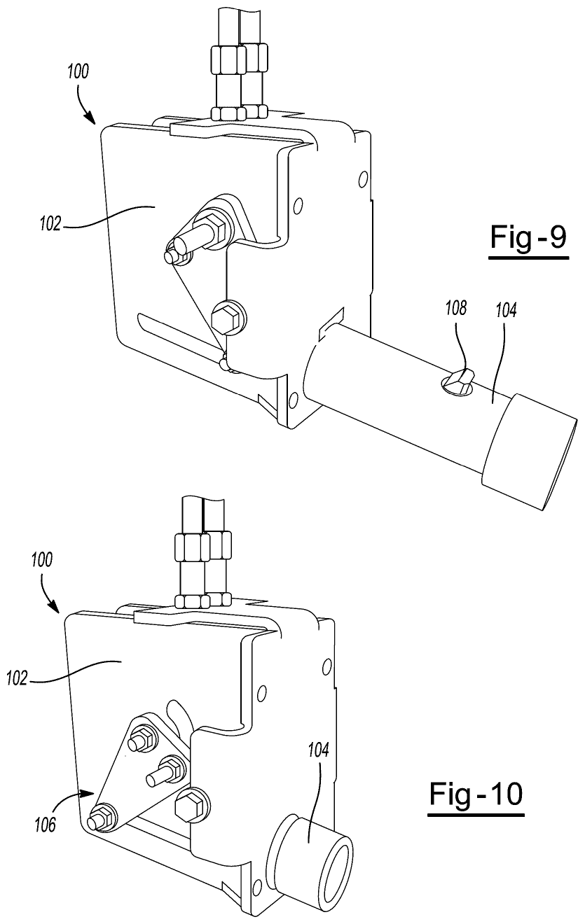

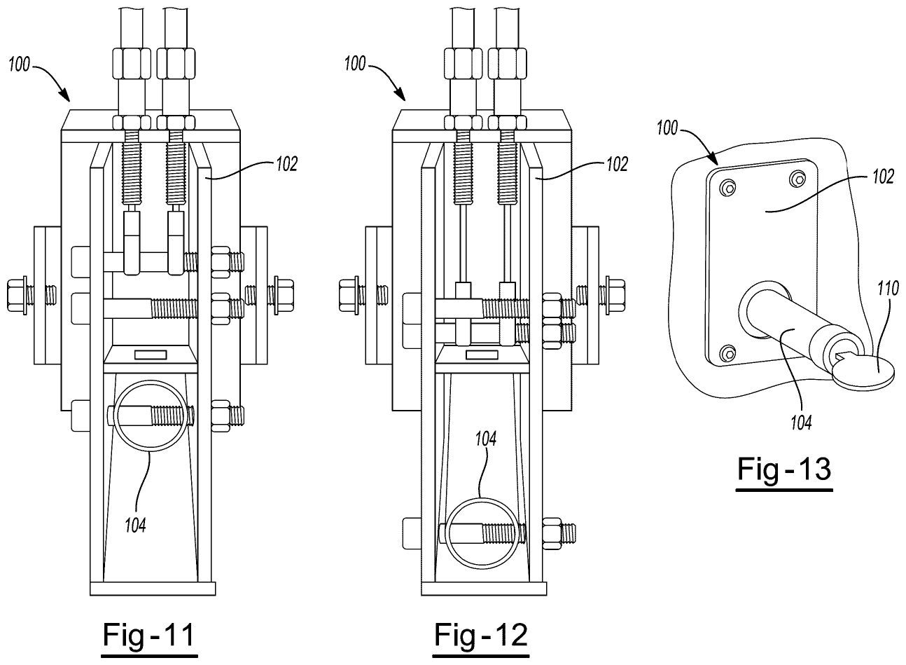

Referring to FIGS. 9-13, a security lock 10 includes a lock assembly 100. The lock assembly 100, is used by an operator to engage or disengage the one or more bolt assemblies 200. The lock assembly 100 is mounted to an interior surface 20 of a vehicle. The lock assembly 100 includes a lock assembly housing 102, a lock cylinder 104, an actuation subassembly 106, and a lock 108.

The lock assembly 100 includes a lock assembly housing 102. The lock assembly housing 102 can be mounted to the interior surface 20 of a vehicle. The lock assembly housing 102 may be mounted to an interior surface 20 using fasteners, adhesives, the like or any combination thereof. The lock assembly 100 housing holds a lock cylinder 104 captive.

The lock assembly 100 includes a lock cylinder 104. The lock cylinder 104 is used by an operator as the primary means to lock and unlock the one or more bolt assemblies 200. The lock cylinder 104 is held captive by the lock assembly housing 102. The lock cylinder 104 can be inserted into the lock assembly housing 102 to lock or unlock the one or more bolt assemblies 200. The lock cylinder 104 can be withdrawn from the lock assembly housing 102 to lock or unlock the one or more bolt assemblies 200. The lock cylinder 104 may be prevented from unlocking by a lock 108. The lock cylinder 104 is attached to an actuation subassembly 106 which transfers the motion of the lock cylinder 104 to a force transfer assembly 300.

The lock assembly includes an actuation subassembly 106. The actuation subassembly 106 transfers the force and/or motion of the lock cylinder 104 to or from the force transfer assembly 300.

The lock assembly 100 includes a lock 108. The lock 108 prevents the lock cylinder 104 from moving from a locked position to an unlocked position when the lock is engaged. The lock 108 may be mounted to the lock assembly housing 102 or the lock cylinder 104. The lock 108 allows the lock cylinder 104 to move from a locked position to an unlocked position when the lock 108 is disengaged. The lock 108 is disengaged by the use of a key 110.

The security lock 10 includes a key 110. The key 110 is used to disengage the lock 108. The key 110 disengages the lock 108 when it is inserted into the lock 108 and rotated. A lock 108 may be unlocked by a unique key, a master key, or both.

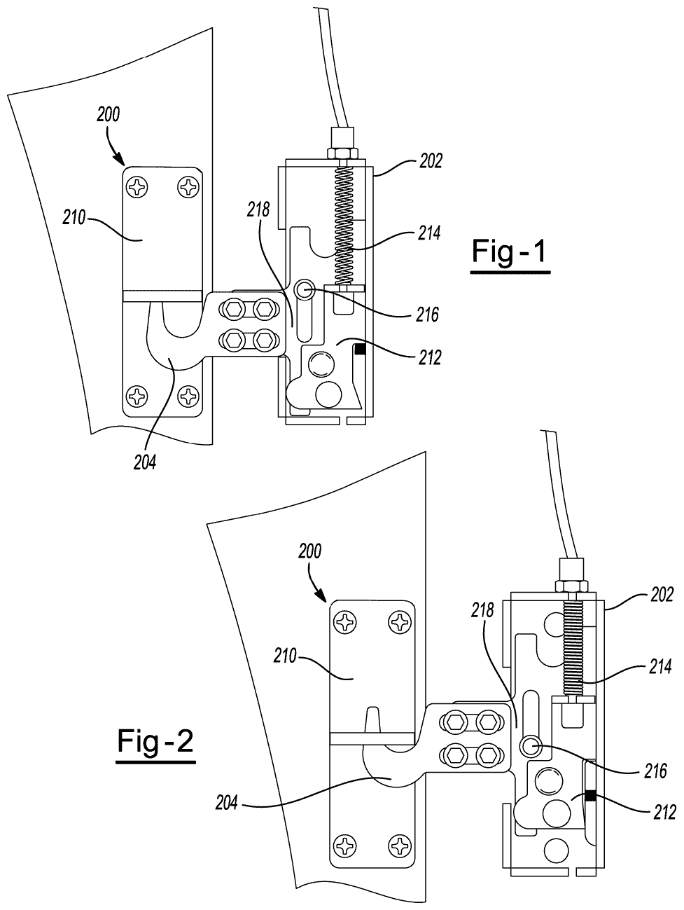

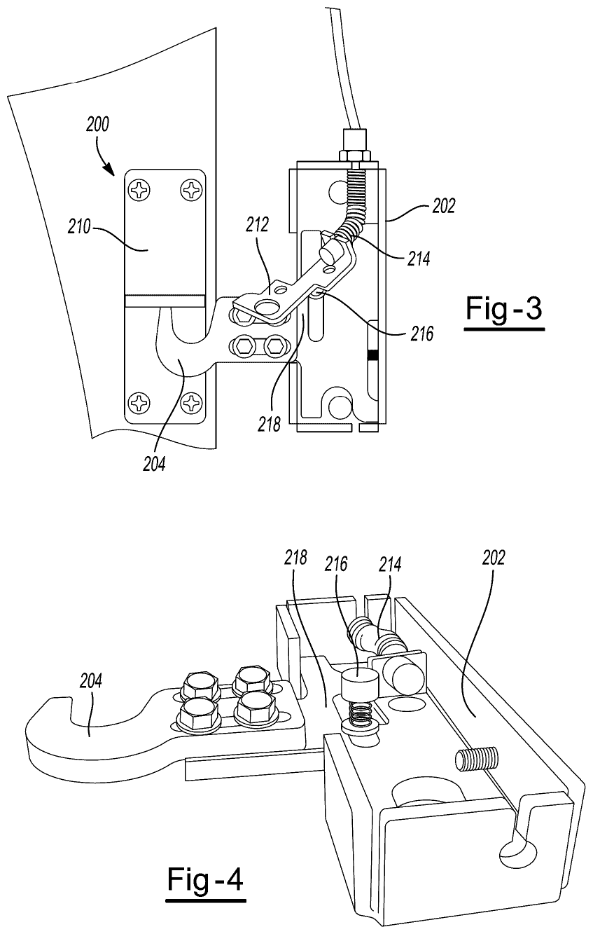

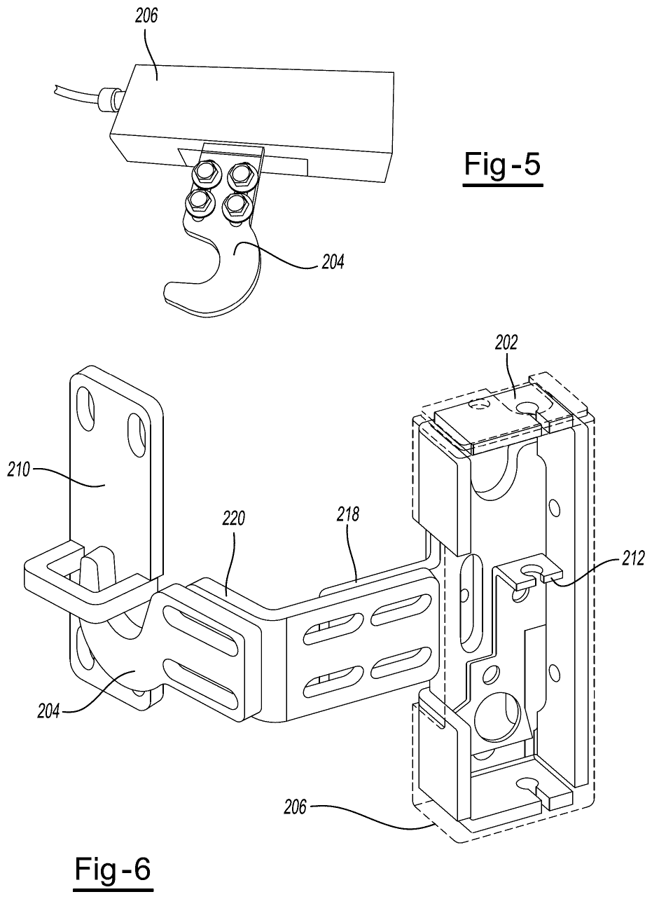

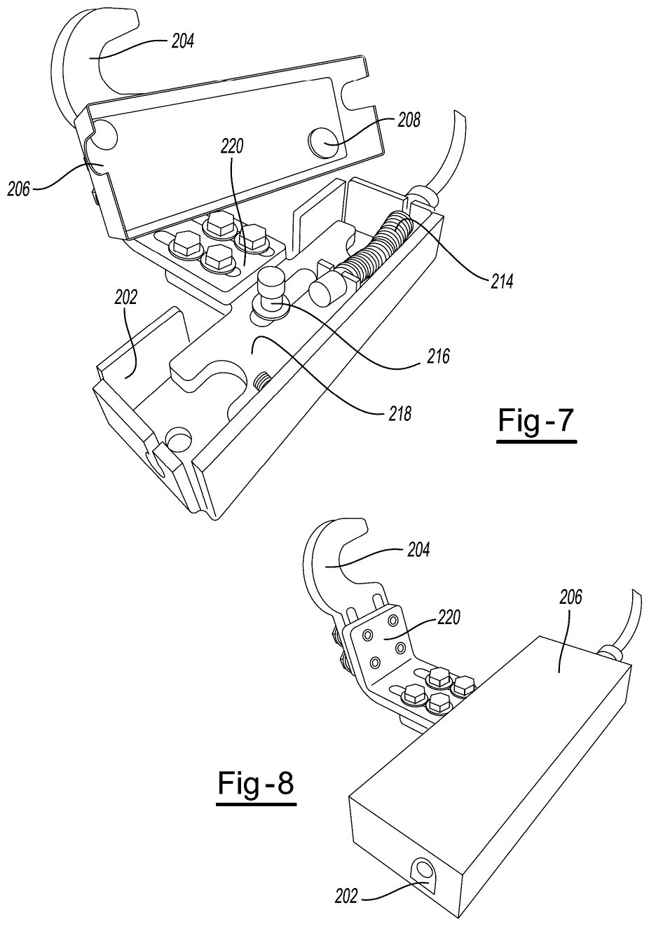

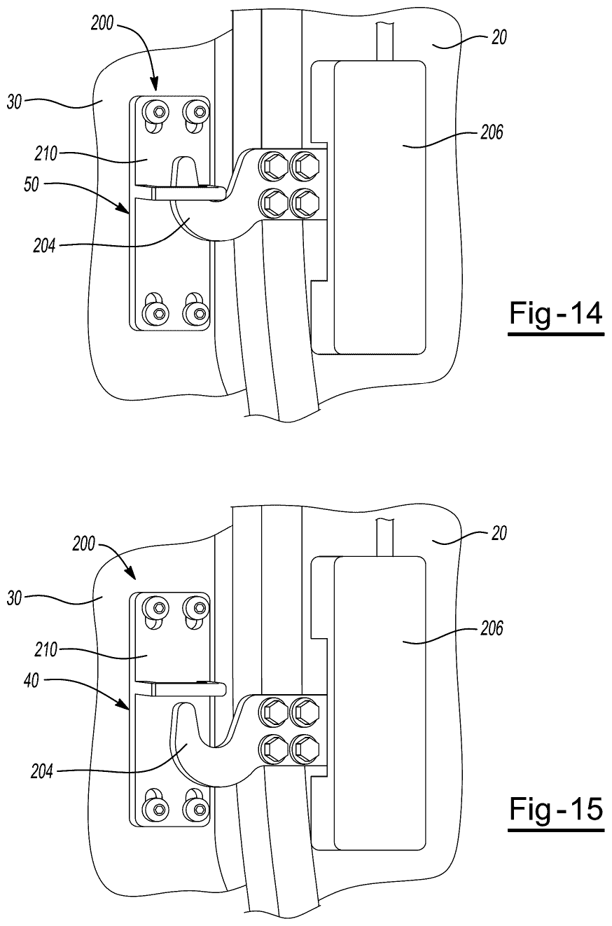

Referring to FIGS. 1-8 and 14-15, the security lock 10 includes one or more bolt assemblies 200. The one or more bolt assemblies 200 physically prevent the opening of a vehicle door or hatch when in the locked position 50. The one or more bolt assemblies 200 allow for a vehicle door or hatch to open when in the unlocked position 40. The one or more bolt assemblies 200 are moved into the locked position 50 or the unlocked position 40 by the lock cylinder 104 of the lock assembly 100. The lock cylinder 104 moves the one or more bolt assemblies 200 into the locked position 50 or unlocked position 40 by mechanical communication through a force transfer assembly 300. The bolt assembly housing 202 is attached to the interior surface 20 or a separate interior surface 30 by affixing a bolt assembly housing 202 to the respective surface.

The bolt assembly 200 includes a bolt assembly housing 202. The bolt assembly housing 202 is mounted to the interior surface 20 or a separate interior surface 30 of a vehicle. The bolt assembly housing 202 can be mounted to the vehicle using fasteners, adhesives, the like, or a combination thereof. The bolt assembly housing 202 at least partially contains a bolt 204. The bolt assembly housing 202 enables the force transfer assembly 300 to move the bolt 204 relative to the bolt assembly housing 202.

The bolt assembly 200 includes a bolt 204. The bolt 204 moves relative to the bolt assembly housing 202 via a slide 218. The bolt 204 moves between a locked position 50 and an unlocked position 40. When the bolt 204 is in the locked position 50 it prevents opening of a door or hatch by mechanically interfering with a bolt receiver 210. The bolt 204 has a hook shape. The bolt 204 may have a hook shape which terminates more than, less than, or at 0 degrees of curve from the axis of travel of the bolt 204. The bolt 204 may be a single piece of material. In some embodiments, as illustrated in FIGS. 6-8, a connector 220 may couple the bolt 204 to the slide 218 using fasteners. Use of the connector 220 to couple the bolt 204 to the slide 218 may allow the bolt 204 to be easily adapted to a wide array of vehicle interior geometries.

The bolt assembly 200 includes a bolt assembly housing cover 206. The bolt assembly housing cover 206 is affixed to the bolt assembly housing 202 to cover interior components during normal operation. The bolt assembly housing cover 206 can be removed for assembly, service, or in the case of an emergency. The bolt assembly housing cover 206 is affixed to the bolt assembly housing 202 through the use of one or more permanent magnets 208.

The bolt assembly housing cover 206 includes a fluorescent coating. The fluorescent coating emits light. The fluorescent coating can assist an operator in finding the bolt assembly 200. The fluorescent coating is painted onto, adhered to, or otherwise marks the bolt assembly housing cover 206.

The bolt assembly 200 includes one or more permanent magnets 208. The one or more permanent magnets 208 affix the bolt assembly housing cover 206 to the bolt assembly housing 202. The one or more permanent magnets 208 allow the bolt assembly housing cover 206 to be removed from and reattached to the bolt assembly housing 202 without the use of any tools.

The bolt assembly 200 includes a bolt receiver 210. The bolt receiver 210 mechanically interferes with a bolt 204 in the locked position 50 to prevent the opening of a door or hatch of a vehicle. The bolt receiver 210 is mounted to a separate interior surface 30 if the bolt assembly housing 202 is mounted to the interior surface 20. The bolt receiver 210 is mounted to the interior surface 20 if the bolt assembly housing 202 is mounted to a separate interior surface 30. The bolt receiver 210 is mounted to the vehicle using fasteners, adhesives, the like, or any combination thereof. The bolt receiver 210 has an opening. The opening of the bolt receiver 210 at least partially contains the bolt 204 when the bolt 204 is in the locked position 50. The opening of the bolt receiver 210 contains no portion of the bolt 204 when the bolt is in the unlocked position 40.

The bolt assembly 200 may have an emergency release 212. The emergency release 212 allows for the bolt 204 to be disengaged from the force transfer assembly 300. The emergency release 212 can be accessed by removing the bolt assembly housing cover 206. The emergency release 212 is a threaded fastener which mechanically links the bolt 204 to the force transfer assembly 300 when inserted. An exemplary emergency release 212 is a thumb screw with a large head diameter such that it can be easily loosened by hand without the assistance of a tool. The emergency release 212 may also have an anti-vibration feature to prevent gradual loosening of the emergency release 212. The anti-vibration feature may be a nylon ring or other suitable feature. The emergency release 212 may include a torque limiting feature. The torque limiting feature may ensure proper installation or reinstallation of the emergency release 212. The torque limiting feature may be achieved by using a thumb screw with a specific head diameter.

The bolt assembly 200 may include a spring 214. The spring 214 provides force which assists the bolt 204 in moving to either the locked position 50 or unlocked position 40. Alternatively, the lock assembly 100 may include a spring.

The bolt assembly 200 includes an auxiliary spring 216. The auxiliary spring 216 biases the bolt 204 towards the bolt assembly housing 202. The auxiliary spring 216 provides sufficient force such that the bolt 204 stays in contact with the bolt assembly housing 202 during normal use of the bolt assembly 200. The auxiliary spring 216 is compressed and allows the bolt 204 to move laterally when a door or hatch is shut while the bolt 204 is in the locked position 50. The compression of the auxiliary spring 216 prevents damage to the bolt 204, the bolt receiver 210, and the vehicle.

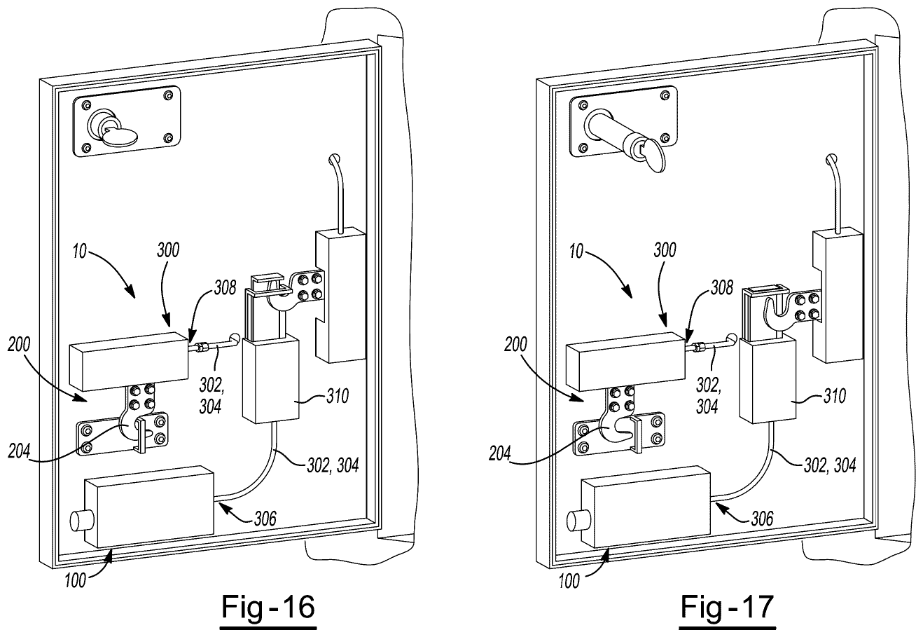

Referring to FIGS. 16 and 17, the security lock 10 includes one or more force transfer assemblies 300. The force transfer assembly 300 transfers force between the lock assembly 100 and the one or more bolt assemblies 200. The force transfer assembly 300 may be a Bowden tube, mechanical linkage, or any other suitable mechanism which transfers force between the lock assembly 100 and one or more bolt assemblies 200.

The force transfer assembly 300 includes a sheath 302. The sheath 302 contains a cable inside 304. The sheath 302 protects the cable 304 and enables the cable 304 to transfer force.

The force transfer assembly 300 includes a cable 304. The cable 304 is the primary force delivery component of the force transfer assembly 300. The cable 304 is held captive in the sheath 302.

The force transfer assembly 300 includes a lock interface 306. The lock interface 306 physically connects the cable 304 to the lock assembly 100.

The force transfer assembly 300 includes a bolt interface 308. The bolt interface 308 physically connects the cable 304 to the bolt 204.

The force transfer assembly 300 may include a tensioner 310. The tensioner 310 adjusts the relative length of the sheath 302. The tensioner 310 can be used to adjust the force transfer assembly 300. The tensioner 310 also connects the sheath 302 to the lock assembly 100, the bolt assembly 200, or both.

The security lock 10 has an unlocked position 40. The unlocked position 40 allows a vehicle door or hatch to open freely. The unlocked position 40 is achieved by withdrawal of the lock cylinder 104 from the lock assembly housing 102. The unlocked position 40 is achieved when the bolt 204 is not at least partially contained by the bolt receiver 210.

The security lock 10 has a locked position 50. The locked position 50 prevents a vehicle door or hatch from opening freely. The locked position 50 is achieved by insertion of the lock cylinder 104 into the lock assembly housing 102. The locked position 50 is achieved when the bolt 204 is at least partially contained by the bolt receiver 210.

It is noted that the terms “substantially” and “about” may be utilized herein to represent the inherent degree of uncertainty that may be attributed to any quantitative comparison, value, measurement, or other representation.

These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the Detailed Description of the Invention of a range in terms of at “‘x’ parts by weight of the resulting polymeric blend composition” also contemplates a teaching of ranges of same recited amount of “x” in percent by weight of the resulting polymeric blend composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of, or even consist of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps. All references herein to elements or metals belonging to a certain Group refer to the Periodic Table of the Elements published and copyrighted by CRC Press, Inc., 1989. Any reference to the Group or Groups shall be to the Group or Groups as reflected in this Periodic Table of the Elements using the IUPAC system for numbering groups.

While particular embodiments have been illustrated and described herein, it should be understood that various other changes and modifications may be made without departing from the spirit and scope of the claimed subject matter.

Moreover, although various aspects of the claimed subject matter have been described herein, such aspects need not be utilized in combination.

It is therefore intended that the appended claims (and/or any future claims filed in any Utility application) cover all such changes and modifications that are within the scope of the claimed subject matter.

Moreover, although various aspects of the claimed subject matter have been described herein, such aspects need not be utilized in combination.

It is therefore intended that the appended claims cover all such changes and modifications that are within the scope of the claimed subject matter.

1. A vehicle security lock comprising:
a) a lock assembly adapted to mount to an interior surface of a vehicle including:
i. a lock assembly housing, and
ii. a lock cylinder that moves relative to the lock assembly housing;
b) one or more bolt assemblies adapted to mount to the interior surface of the vehicle where each bolt assembly includes:
i. a bolt assembly housing,
ii. a bolt which moves relative to the bolt assembly housing,
iii. a bolt assembly housing cover which is affixable to the bolt assembly housing, and
iv. a bolt receiver mounted to a separate interior surface of the vehicle;
c) one or more force transfer assemblies which mechanically transfer force between the lock assembly and each of the one or more bolt assemblies;
wherein insertion of the lock cylinder into the lock assembly provides force through the one or more force transfer assemblies to each of the one or more bolt assemblies and moves the bolt of each of the one or more bolt assemblies into a locked position;
wherein withdrawal of the lock cylinder from the lock assembly relieves the force through the one or more force transfer assemblies to each of the one or more bolt assemblies and allows the bolt of each of the one or more bolt assemblies to move into an unlocked position.

2. The vehicle security lock of claim 1, wherein the bolt assembly housing cover includes a fluorescent coating.

3. The vehicle security lock of claim 1, wherein the one or more bolt assemblies further include an emergency release which disengages the bolt from the one or more force transfer assemblies.

4. The vehicle security lock of claim 3, wherein the emergency release is a threaded fastener.

5. The vehicle security lock of claim 4, wherein the emergency release is a thumb screw.

6. The vehicle security lock of claim 4, wherein the emergency release has a vibration resistant feature.

7. The vehicle security lock of claim 4, wherein the emergency release has a torque limiting feature.

8. The vehicle security lock of claim 1, wherein the bolt assembly housing cover is affixable to the bolt assembly housing using one or more permanent magnets.

9. The vehicle security lock of claim 1, wherein the lock assembly has a lock which is affixed to the lock assembly housing or the lock cylinder.

10. The vehicle security lock of claim 1, wherein the lock assembly includes a spring, wherein the one or more bolt assemblies include a spring, or both.

11. The vehicle security lock of claim 1, wherein the one or more bolt assemblies include an auxiliary spring which biases the bolt in a direction normal to a direction of travel between the unlocked position and the locked position.

12. The vehicle security lock of claim 11, wherein the auxiliary spring is compressed when the bolt is in the locked position before the separate interior surface is secured to the interior surface.

13. A process for locking doors of a vehicle comprising the steps of:
1) inserting a lock cylinder into a lock assembly housing;
2) transferring force from a lock assembly to one or more bolt assemblies through a force transfer assembly; and
3) a force moving a bolt into a locked position.

14. A security lock comprising:
a) a lock assembly adapted to mount to an interior surface including:
i. a lock assembly housing, and
ii. a lock cylinder that moves relative to the lock assembly housing;
b) one or more bolt assemblies adapted to mount to the interior surface where each bolt assembly includes:
i. a bolt assembly housing,
ii. a bolt which moves relative to the bolt assembly housing,
iii. a bolt assembly housing cover which is affixable to the bolt assembly housing, and
iv. a bolt receiver mounted to a separate interior surface;
c) one or more force transfer assemblies which mechanically transfer force between the lock assembly and each of the one or more bolt assemblies;
wherein insertion of the lock cylinder into the lock assembly provides force through the one or more force transfer assemblies to each of the one or more bolt assemblies and moves the bolt of each of the one or more bolt assemblies into a locked position;
wherein withdrawal of the lock cylinder from the lock assembly relieves the force through the one or more force transfer assemblies to each of the one or more bolt assemblies and allows the bolt of each of the one or more bolt assemblies to move into an unlocked position.

15. The security lock of claim 14, wherein the bolt assembly housing cover includes a fluorescent coating.

16. The security lock of claim 14, wherein the one or more bolt assemblies further include an emergency release which disengages the bolt from the one or more force transfer assemblies.

17. The security lock of claim 14, wherein the bolt assembly housing cover is affixable to the bolt assembly housing using one or more permanent magnets.

18. The security lock of claim 14, wherein the lock assembly has a lock which is affixed to the lock assembly housing or the lock cylinder.

19. The security lock of claim 14, wherein the lock assembly includes a spring, wherein the one or more bolt assemblies include a spring, or both.

20. The security lock of claim 14, wherein the one or more bolt assemblies include an auxiliary spring which biases the bolt in a direction normal to a direction of travel between the unlocked position and the locked position, and wherein the auxiliary spring is compressed when the bolt is in the locked position before the separate interior surface is secured to the interior surface.
